(19) United States
(12) Patent Application Publication
(10) Pub. No.: US 2026/0312766 A1
(43) Pub. Date: Oct. 8, 2026

(54) Methods And Appratus For Bidirectional Channel Estimation In Mobile Communications

(71) Applicant: MediaTek Inc., Hsinchu City (TW)

(72) Inventors: Tzu-Han Chou, San Jose, CA (US); Chia-Hao Yu, Hsinchu City (TW); Chin-Kuo Jao, Hsinchu City (TW); Cheng-Rung Tsai, Hsinchu City (TW); Sriharsha Ramarao Magani, Bengaluru (IN)

(73) Assignee: MediaTek Inc., Hsinchu City (TW)

(21) Appl. No.: 19/632,450

(22) Filed: Mar. 30, 2026

(30) Foreign Application Priority Data
Apr. 7, 2025 (IN) 202521033905

(51) Int. Cl. H04L 5/00

(52) U.S. Cl. CPC H04L 5/0051

(57) ABSTRACT

Various solutions for bidirectional channel estimation with respect to an apparatus in mobile communications are described. The apparatus may receive a first precoded reference signal precoded by a first precoder. The apparatus may determine a second precoder according to the first precoded reference signal. The apparatus may transmit a second precoded reference signal precoded by the second precoder for updating the first precoder.

### CROSS REFERENCE TO RELATED PATENT APPLICATION(S)

The present disclosure is part of a non-provisional application claiming the priority benefit of IN application No. 202521033905, filed on 7 Apr. 2025, the content of which herein being incorporated by reference in its entirety.

### TECHNICAL FIELD

The present disclosure is generally related to mobile communications and, more particularly, to bidirectional channel estimation with respect to apparatus in mobile communications.

### BACKGROUND

Unless otherwise indicated herein, approaches described in this section are not prior art to the claims listed below and are not admitted as prior art by inclusion in this section.

In New Radio (NR) and next generation mobile communication systems, Multiple-Input Multiple-Output (MIMO) techniques are widely adopted to improve network performance. In such systems, Channel State Information (CSI) may be important for improving various transmission techniques. Therefore, various CSI acquisition schemes have been proposed.

In some scenarios, an explicit CSI feedback scheme may be utilized. In particular, a receiver may measure CSI using reference signals and transmit the measured information (e.g., a CSI report) back to a transmitter. However, the overhead and resource consumption associated with such schemes may increase with the number of transmit antennas. In some scenarios, an implicit CSI acquisition may be utilized. In particular, channel reciprocity, which may allow channel conditions in one transmission direction to be inferred from signals transmitted in the opposite direction in Time-Division Duplex (TDD) systems, may be exploited to enable implicit CSI acquisition. However, although utilizing channel reciprocity may reduce feedback overhead, it may also experience limitations due to practical constraints, such as asymmetric transmission capabilities between communication devices.

Accordingly, there remains a need for improved channel estimation schemes in mobile communication systems that may efficiently obtain channel information while reducing signaling overhead and maintaining reliable performance under varying channel conditions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to bidirectional channel estimation with respect to apparatus in mobile communications.

In one aspect, a method may involve an apparatus receiving a first precoded reference signal precoded by a first precoder. The method may further involve the apparatus determining a second precoder according to the first precoded reference signal. The method may further involve the apparatus transmitting a second precoded reference signal precoded by the second precoder for updating the first precoder.

In one aspect, a method may involve an apparatus transmitting a first precoded reference signal precoded by a first precoder for determining a second precoder. The method may further involve the apparatus receiving a second precoded reference signal precoded by the second precoder. The method may further involve the apparatus updating the first precoder according to the second precoded reference signal.

In one aspect, a method may involve an apparatus receiving at least one control signaling indicating a reception of a first precoded reference signal and a transmission of a second precoded reference signal. At least one first Physical Resource Block (PRB) bundle boundary of the first precoded reference signal may correspond to at least one second PRB bundle boundary of the second precoded reference signal.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, at least one control signaling indicating a reception of a first precoded reference signal and a transmission of a second precoded reference signal. At least one first PRB bundle boundary of the first precoded reference signal may correspond to at least one second PRB bundle boundary of the second precoded reference signal.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to bidirectional channel estimation with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a first apparatus may transmit a first precoded reference signal. The first precoded reference signal may be precoded by a first precoder. A second apparatus may receive the first precoded reference signal and determine a second precoder according to the first precoded reference signal. The second apparatus may then transmit a second precoded reference signal. The second precoded reference signal may be precoded by the second precoder. The first apparatus may receive the second precoded reference signal and update the first precoder according to the second precoded reference signal. In some cases, the above operations may be iteratively performed by the first apparatus and the second apparatus to refine the first precoder and the second precoder, respectively.

In some scenarios, the above operations may be performed based on some configurations. In particular, prior to performing the above operations, the first apparatus may transmit at least one control signaling to the second apparatus. The at least one control signaling may indicate a reception of the first precoded reference signal and a transmission of the second precoded reference signal. In some cases, for enabling consistent channel estimations between the first precoded reference signal and the second precoded reference signal, at least one first Physical Resource Block (PRB) bundle boundary of the first precoded reference signal may correspond to at least one second PRB bundle boundary of the second precoded reference signal.

Accordingly, the above bidirectional channel estimation may be iteratively performed between the first apparatus and the second apparatus, such that channel information may be progressively refined without requiring significant legacy CSI reporting, thereby reducing signaling overhead while maintaining reliable performance.

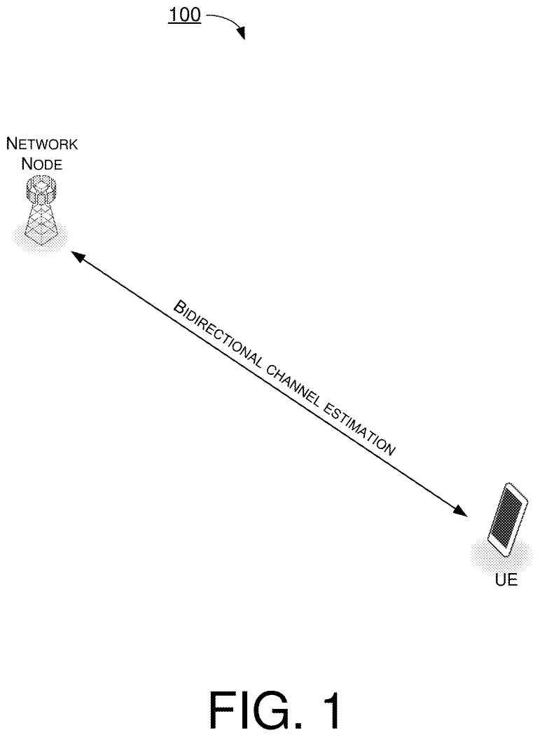

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more network nodes.

It should be noted that the roles of the UE and the network node illustrated in FIG. 1 are merely exemplary and are not intended to limit the present disclosure. Based on the present disclosure, a person skilled in the art will readily appreciate that the roles of the UE and the network node may be interchanged in various implementations.

In some embodiments, a bidirectional channel estimation may be iteratively performed between the network node and the UE. In particular, during an initial stage, the network node may initialize a first precoder. In some cases, the first precoder may be a matrix corresponding to a pre-estimated channel. In some cases, the first precoder may be an identity matrix.

In some implementations, during a first iteration, the network node may transmit a first precoded reference signal to the UE using the first precoder (i.e., the first precoded reference signal may be precoded by the first precoder). The UE may receive the first precoded reference signal. Then, the UE may determine a second precoder based on the first precoded reference signal. The UE may transmit a second precoded reference signal to the network node using the second precoder (i.e., the second precoded reference signal may be precoded by the second precoder). The network node may receive the second precoded reference signal and update the first precoder based on the second precoded reference signal. During the first iteration, each of the network node and the UE may determine or refine its respective channel-related precoder using the corresponding reference signal without requiring any CSI report.

In some implementations, during a second iteration, the network node may transmit a third precoded reference signal to the UE using the first precoder (i.e., the third precoded reference signal may be precoded by the first precoder). The UE may receive the third precoded reference signal. Then, the UE may update the second precoder based on the third precoded reference signal. The UE may transmit a fourth precoded reference signal to the network node using the second precoder (i.e., the fourth precoded reference signal may be precoded by the second precoder). The network node may receive the fourth precoded reference signal and update the first precoder based on the fourth precoded reference signal. During the second iteration, each of the network node and the UE may determine or refine its respective channel-related precoder using the corresponding reference signal without requiring any CSI report.

In some implementations, the iteration may be repeatedly performed by the network node and the UE to further refine the channel-related precoders so that the precoders may better adapt to channel variations.

In some implementations, determining or updating the second precoder according to the corresponding precoded signal (e.g., the first precoded signal or the third precoded reference signal) may include: (1) determining an equivalent channel corresponding to the corresponding precoded reference signal, and (2) determining or updating the second precoder based on the equivalent channel.

More specifically, the first precoder may be represented by W. The reference signal precoded by the first precoder and transmitted from the network node may be expressed as:

$${HWs}_{dl} + {n}_{dl}$$

wherein H denotes a channel matrix between the network node and the UE, s_{dl} denotes a Downlink (DL) reference signal vector (including data or reference signal symbol), and n_{dl} denotes a noise vector associated with DL transmission.

The UE may receive the precoded reference signal and determine an appropriate filter Q for optimizing data transmission. The processing of the precoded reference signal may be expressed as:

$$Q H W {s}_{dl} + Q {n}_{dl}$$

The equivalent channel H_{eq} may be QHW. Then, the UE may determine the filter Q for optimizing data transmission.

In some cases, the UE may determine the filter Q that maximizes a channel related function. For example, the UE determines the filter Q according to:

$$Q = {arg max}_{Q} C ( Q HW )$$

where C denotes a channel capacity function, and argmax denotes an operator that selects a value of Q that maximizes the channel capacity. After determining the filter Q, the UE may determine or update the second precoder according to the filter Q. The second precoder may be a transpose of the filter Q, which is Q^{T}.

In some implementations, the first precoder may be initiated as a matrix corresponding to a pre-estimated channel or an identity matrix. Updating the first precoder according to the corresponding precoded signal (e.g., the second precoded signal or the fourth precoded reference signal) may include: (1) determining an equivalent channel corresponding to the corresponding precoded reference signal, and (2) updating the first precoder based on the equivalent channel.

More specifically, the second precoder may be represented by Q^{T}. The reference signal precoded by the second precoder transmitted from the UE may be expressed as:

$${H}^{T} {Q}^{T} {s}_{ul}$$

wherein H^{T} denotes a channel matrix between the UE and the network node, sᵤₗ denotes an Uplink (UL) reference signal vector (including data or reference signal symbol).

The network node may receive the precoded reference signal and determine an appropriate filter W^{T} for optimizing data transmission. The processing of the precoded reference signal may be expressed as:

$${W}^{T} {H}^{T} {Q}^{T} {s}_{ul} + {W}^{T} {n}_{ul}$$

The equivalent channel H_{eq} may be W^{T}H^{T}Q^{T}. Then, the network node may determine the filter W^{T} for optimizing data transmission.

In some cases, the network may determine the filter W^{T} that maximizes a channel related function. For example, the network node determines the filter according to:

$${W}^{T} = {arg max}_{{W}^{T}} C ( {W}^{T} {H}^{T} {Q}^{T} )$$

where C denotes a channel capacity function with color interference W^{T} nᵤₗ, and argmax denotes an operator that selects a value of W^{T} that maximizes the channel capacity. After determining the filter W^{T}, the UE may update the first precoder according to the filter W^{T}. The first precoder may be a transpose of the filter W^{T}, which is W.

In some cases, W∈ [symbol] ⁿ^{ₜ}^{×L} and Q∈ [symbol] ^{L×n}^{ᵣ}, where nₜ denotes the number of antennas of the network node, and nᵣ denotes the number of antennas of the UE. H includes nᵣ×nₜ matrix. Each of s_{dl} and sᵤₗ is an L×1 vector, where L denotes port number or layer number.

Accordingly, the above bidirectional channel estimation may be capable of adapting to channel variations. Unlike single-directional channel estimation, each iteration may provide the receiver (e.g., the network node or the UE) with direct access to the full-dimensional channel output (e.g., nᵣ or nₜ) during the estimation process. By determining an optimal receiver configuration, the UE and the network node may adapt to channel variations, and the resulting configuration may be subsequently used as a precoder in a subsequent estimation phase.

In some implementations, the precoded reference signal(s) transmitted from the network node to the UE (e.g., the first precoded reference signal and the third precoded reference signal) may include a DL-Demodulation Reference Signal (DL-DMRS) or a Channel State Information-Reference Signal (CSI-RS). The precoded reference signal(s) transmitted from the UE to the network node (e.g., the second precoded reference signal and the fourth precoded reference signal) may include an UL-DMRS or a Sounding Reference Signal (SRS).

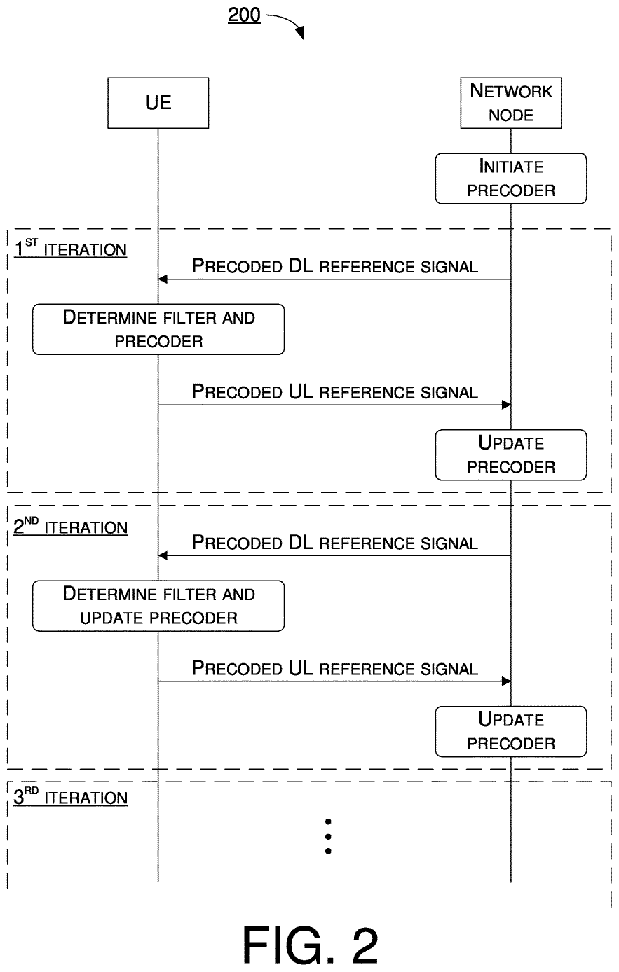

FIG. 2 illustrates an example scenario 200 under schemes in accordance with implementations of the present disclosure. In some implementations, the network node may set rank L and initiate a precoder W⁽⁰⁾∈ [symbol] ⁿ^{ₜ}^{×L}. In each iteration k=1, 2, . . . , the following operations may be performed: (1) the network node may transmit a precoded DL reference signal W^{(k-1)} s_{dl}, (2) the UE may receive a channel output y_{dl}∈ [symbol] ⁿ^{ᵣ}^{×1} corresponding to the precoded DL reference signal W^{(k-1)} s_{dl} and estimate equivalent channel HW^{(k)}, (3) the UE may determine a filter Q^{(k)} ∈ [symbol] ^{L×n}^{ᵣ} based on the equivalent channel HW^{(k)}, (4) the UE may use Q^{(k)} to determine a precoder Q^{(k)}^{^{T}} and transmit a precoded UL reference signal Q^{(k)}^{^{T}} sᵤₗ, (5) the network node may receive a channel output yᵤₗ∈ [symbol] ⁿ^{ₜ}^{×1} corresponding to the precoded UL reference signal

$${Q}^{{( k )}^{T}} {s}_{ul} ,$$

estimate equivalent channel H^{T} Q^{T (k)}, (6) the network node may determine a filter W^{(k)}^{^{T}} based on the equivalent channel H^{T} Q^{T (k)}, and update the precoder W^{(k-1)} as W^{(k)} ∈ [symbol] ⁿ^{ₜ}^{×L}.

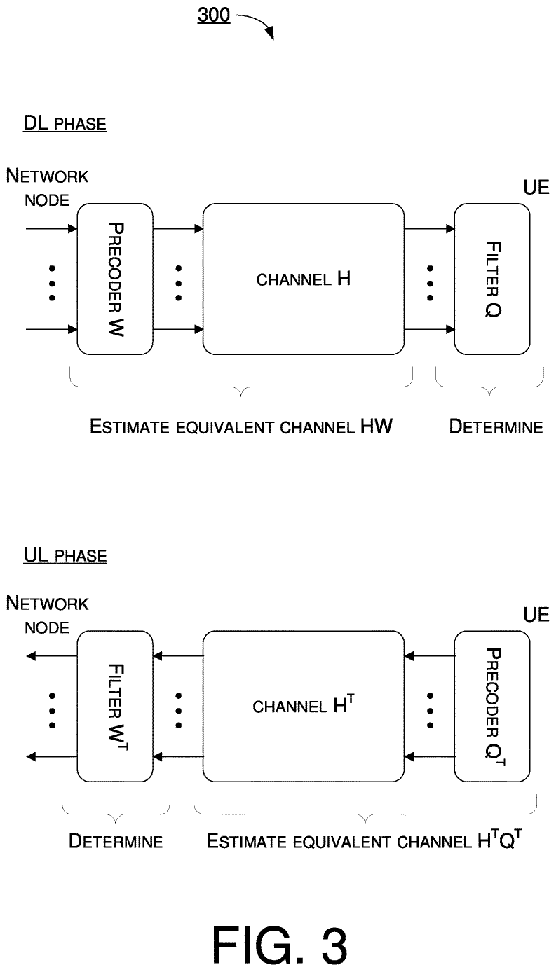

FIG. 3 illustrates an example scenario 300 under schemes in accordance with implementations of the present disclosure. In some implementations, regarding a DL phase, the network node may determine a precoder W from an optimized filter W^{T} and transmit a reference signal by using the precoder W. The UE may estimate an equivalent channel HW based on the received reference signal precoded by the precoder W and determine an optimized filter Q for data transmission. Regarding a UL phase, the UE may determine a precoder Q^{T} from the optimized filter Q and transmit reference signal by using the precoder Q^{T}. The network node may estimate an equivalent channel H^{T} Q^{T} based on the received reference signal precoded by the precoder Q^{T}.

In some implementations, at least one first PRB bundle boundary of the first precoded reference signal may correspond to at least one second PRB bundle boundary of the second precoded reference signal. More specifically, the at least one first PRB bundle boundary and the at least one second PRB bundle boundary may be aligned (e.g., configured to be the same), and aligning the PRB bundle boundaries may ensure that the two precoded reference signals may be mapped to the same frequency-domain resource structure, thereby maintaining consistent precoding granularity across the two transmissions. Such alignment may facilitate coherent channel estimation and processing across PRB bundles, and may avoid performance degradation that may otherwise result from mismatched PRB bundle configurations.

In some embodiments, since the bidirectional channel estimation may involve both DL and UL reference signals, corresponding configurations may be aligned. In particular, the network node may transmit at least one control signaling to the UE. The UE may receive the at least one control signaling. The at least one control signaling may indicate a reception of a first precoded reference signal (i.e., DL reference signal) transmitted from the network node to the UE (e.g., the above first precoded reference signal and/or third precoded reference signal) and a transmission of a second precoded reference signal (i.e., UL reference signal) transmitted from the UE to the network node (e.g., the above second precoded reference signal and/or fourth precoded reference signal).

The at least one control signaling may further indicate that at least one first PRB bundle boundary of the first precoded reference signal may correspond to at least one second PRB bundle boundary of the second precoded reference signal. In other words, the PRB bundle boundary of the second precoded reference signal may be correspondingly aligned with the PRB bundle boundary of the first precoded reference signal.

In some cases, the at least one control signaling may include: (1) a first control signaling indicating the reception of the first precoded reference signal, and (2) a second control signaling indicating the transmission of the second precoded reference signal. In some cases, the at least one control signaling may include one control signaling (i.e., the first control signaling and the second control signaling are the same) indicating both the reception of the first precoded reference signal and the transmission of the second precoded reference signal.

In some implementations, the at least one control signaling may include a transmission parameter set associated with the transmission of the second precoded reference signal. The transmission parameter set may include at least one of: (1) a frequency domain resource allocation, (2) a reference signal comb size, and (3) a Precoding Resource block Group (PRG) bundle boundary and size.

In some cases, when the at least one control signaling for both DL reference signal (i.e., the first precoded reference signal) and UL reference signal (i.e., the second precoded reference signal) includes Downlink Control Information DCI(s) and is dynamically indicated, the frequency domain resource allocation may specify a Bandwidth (BW) and a location for DL reference signal, and the same frequency domain resource allocation may be applied to the UL reference signal.

In some cases, when the at least one control signaling for both DL reference signal and UL reference signal includes a Radio Resource Control (RRC) signaling and corresponding resources are configured by the RRC signaling, the transmission parameter set may include the frequency domain resource allocation, the reference signal comb size, and other parameters for deriving the waveform.

In some cases, the UL reference signal may perform frequency hopping, and the frequency resources for different hops may be configured within the BW indicated by the DCI or the RRC signaling.

In some cases, the PRG sizes for the DL reference signal and the UL reference signal may be determined based on the same control signaling (e.g., DCI or RRC signaling). Each PRG size may correspond to a wideband bundle or an N-PRB bundle (N≥1), where N PRBs constitute one bundle.

In some cases, regarding the bundling grids of the DL reference signal and the UL reference signal, (1) the bundle boundaries of the DL reference signal and the UL reference signal may be aligned, while the bundle size of the reference signal in one direction (e.g., the UL direction) is smaller than that in the other direction (e.g., the DL direction); or (2) the bundle size (N) of the reference signal in one direction may be an integer multiple of that in the other direction.

In some implementations, numbers of UL reference signal ports and DL reference signal ports may be configured based on the at least one control signaling. In some cases, the number of UL reference signal ports may be indicated from the at least one control signaling (e.g., a DCI) that triggers the UL reference signal transmission. In some cases, the number of DL reference signal ports may be indicated from the at least one control signaling as well.

In some cases, the at least one control signaling may include indication indicating the number of UL reference signal ports and/or which ports to be transmitted. The indication may include a maximum number of UL reference signal ports. The UE may select a subset of UL reference signal ports for transmission, while the subset may have a port number smaller than the maximum number.

In some implementations, the UL reference signal for transmission may be divided into a first part UL reference signal and a second part UL reference signal. In some cases, the UL reference signal ports may be shared between the first part UL reference signal and the second part UL reference signal.

In some cases, the at least one control signaling may indicate a subset of UL reference signal ports to be transmitted. In particular, a number of ports for the first part UL reference signal transmission may be indicated, and a number of ports for the second part UL reference signal transmission may be derived accordingly.

For example, when a total number of the UL reference signal ports is provided, the number of ports for the second part UL reference signal is determined by subtracting the indicated number of ports for the first part UL reference signal transmission from the total number of ports.

In some cases, the subset of UL reference signal ports to be transmitted may correspond to a subset of antennas, and another subset of UL reference signal ports may correspond to another subset of the antennas.

In some cases, the first part UL reference signal transmission and the second part UL reference signal transmission may be Time-Division Multiplexed (TDM-ed). In some cases, the first part UL reference signal may include UL-DMRS, and the second part UL reference signal may include SRS.

In some implementations, different DL reference signal and UL reference signal type combinations may be used for various scenarios.

In some cases, the DL reference signal may include DL-DMRS, and the UL reference signal may include UL-DMRS. In these cases, corresponding triggering signal for the DL-DMRS may include a DCI, and the UL-DMRS may follow a DCI scheduling UL transmission with or without UL data. In these cases, the UL-DMRS may be determined based on an associated DL-DMRS. For example, parameters including the number of UL-DMRS ports L and the transmission bandwidth may be derived from the associated DL-DMRS. The associated DL-DMRS may be explicitly signaled or implicitly determined (e.g., based on a previous DL-DMRS transmission). In addition, the number of UL-DMRS ports may be different from (e.g., greater than) the number of MIMO layers used for data transmission.

In some cases, the DL reference signal may include CSI-RS, and the UL reference signal may include SRS. In these cases, a DCI may trigger a CSI-RS resource followed by an SRS resource. The CSI-RS resource and the SRS resource (e.g., for non-codebook-based transmission) may be associated and configured via RRC signaling, with parameters for bidirectional channel estimation (e.g., number of ports, bandwidth, etc.) aligned between the two resources. In these cases, such configuration may be performed implicitly, for example by deriving the parameters of the SRS resource based on the associated CSI-RS resource.

In some cases, the DL reference signal may include DL-DMRS, and the UL reference signal may include SRS. In these cases, a DCI may provide a DL assignment (with or without data) and trigger an aperiodic precoded SRS transmission. In such cases, multiple non-codebook-based SRS resources associated with UL TCI states and different numbers of ports may be configured via an RRC signaling. A rank indicated by the DCI may determine which SRS resource, having the corresponding number of ports, may be transmitted.

In some cases, the DL reference signal may include CSI-RS, and the UL reference signal may include UL-DMRS. In some cases, the DL reference signal may include CSI-RS, and the UL reference signal may include UL-DMRS and/or SRS. In these cases, some UL ports may be associated with the UL-DMRS while other UL ports may be associated with the SRS.

### Illustrative Implementations

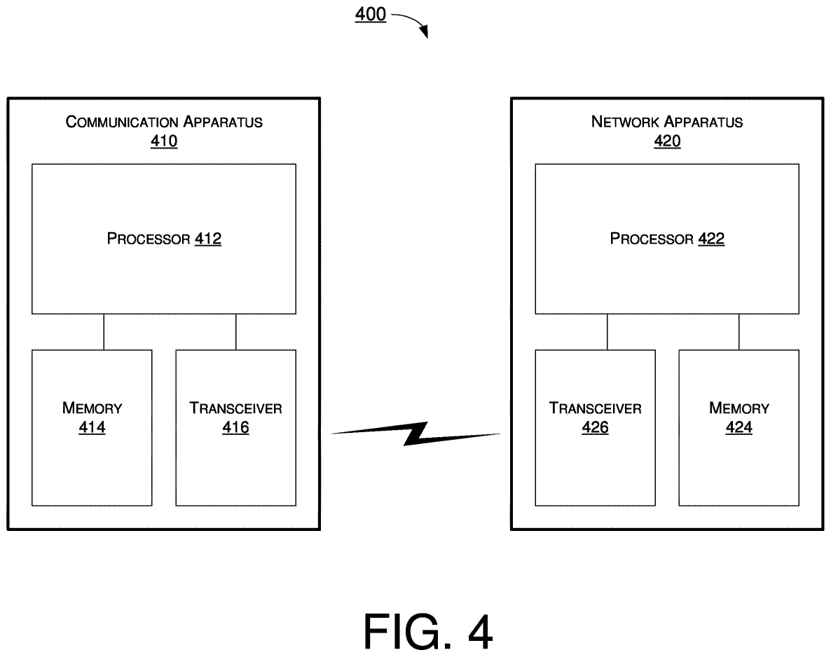

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to bidirectional channel estimation with respect to UE and network apparatus in mobile communications, including scenarios/schemes described above as well as processes 500, 600 and 700 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wired communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including bidirectional channel estimation in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In other words, processor 412 may transceive the data such as configuration, message, signal, information, indicator, etc. via transceiver 416. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In other words, processor 422 may transceive the data such as configuration, message, signal, information, indicator, etc. via transceiver 426. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

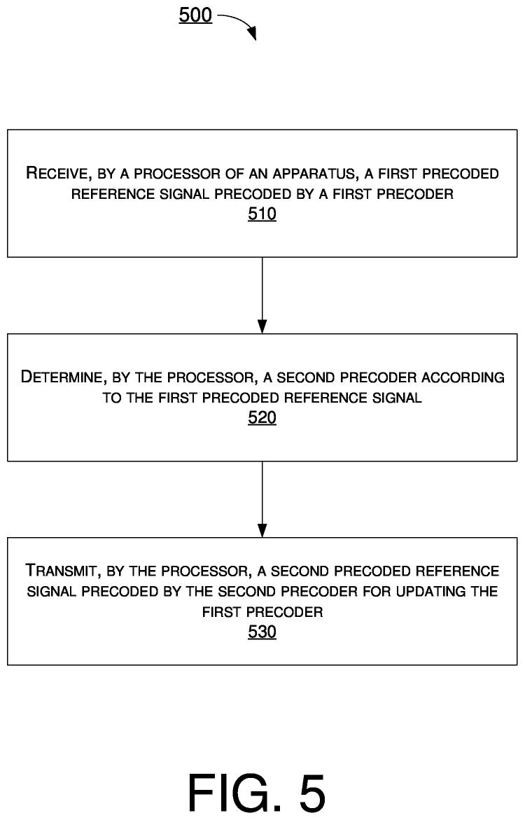

FIG. 5 illustrates an example process 500 in accordance with an implementation of the present disclosure. Process 500 may be an example implementation of above scenarios/schemes, whether partially or completely, with respect to bidirectional channel estimation of the present disclosure. Process 500 may represent an aspect of implementation of features of communication apparatus 410/network apparatus 420. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410/network apparatus 420 or any suitable UE, network device or machine type devices. Solely for illustrative purposes and without limitation, process 500 is described below in the context of communication apparatus 410/network apparatus 420. Process 500 may begin at block 510.

At block 510, process 500 may involve processor 412/422 of communication apparatus 410/network apparatus 420 receiving a first precoded reference signal precoded by a first precoder. Process 500 may proceed from block 510 to block 520.

At block 520, process 500 may involve processor 412/422 of communication apparatus 410/network apparatus 420 determining a second precoder according to the first precoded reference signal. Process 500 may proceed from block 520 to block 530.

At block 530, process 500 may involve processor 412/422 of communication apparatus 410/network apparatus 420 transmitting a second precoded reference signal precoded by the second precoder for updating the first precoder.

In some implementations, process 500 may further involve processor 412/422 determining an equivalent channel corresponding to the first precoded reference signal. Process 500 may further involve processor 412/422 determining the second precoder according to a filter.

In some implementations, process 500 may further involve processor 412/422 receiving a third precoded reference signal precoded by the updated first precoder. Process 500 may further involve processor 412/422 updating the second precoder according to the third precoded reference signal. Process 500 may further involve processor 412/422 transmitting a fourth precoded reference signal precoded by the updated second precoder for updating the first precoder.

In some implementations, the first precoded reference signal may include a DL-DMRS or a CSL-RS. The second precoded reference signal may include an UL-DMRS or an SRS.

In some implementations, at least one first PRB bundle boundary of the first precoded reference signal may correspond to at least one second PRB bundle boundary of the second precoded reference signal.

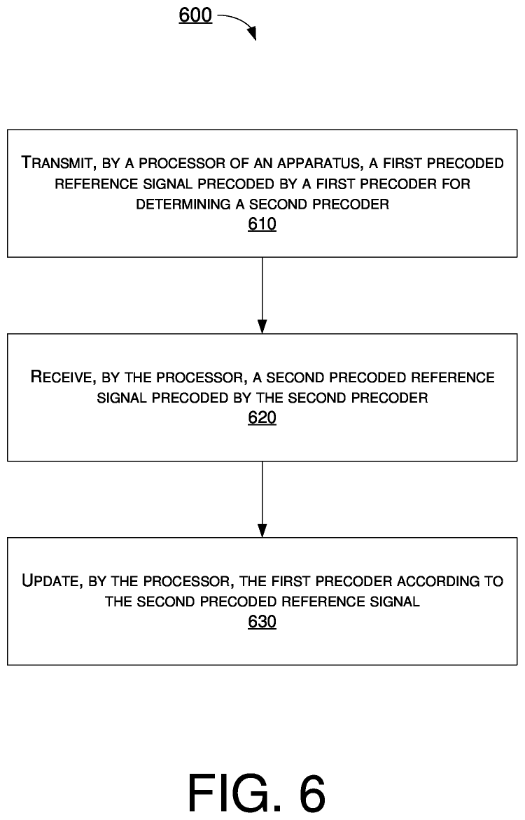

FIG. 6 illustrates an example process 600 in accordance with an implementation of the present disclosure. Process 600 may be an example implementation of above scenarios/schemes, whether partially or completely, with respect to bidirectional channel estimation of the present disclosure. Process 600 may represent an aspect of implementation of features of communication apparatus 410/network apparatus 420. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 410/network apparatus 420 or any suitable UE, network device or machine type devices. Solely for illustrative purposes and without limitation, process 600 is described below in the context of communication apparatus 410/network apparatus 420. Process 600 may begin at block 610.

At block 610, process 600 may involve processor 412/422 of communication apparatus 410/network apparatus 420 transmitting a first precoded reference signal precoded by a first precoder for determining a second precoder. Process 600 may proceed from block 610 to block 620.

At block 620, process 600 may involve processor 412/422 of communication apparatus 410/network apparatus 420 receiving a second precoded reference signal precoded by the second precoder. Process 600 may proceed from block 620 to block 630.

At block 630, process 600 may involve processor 412/422 of communication apparatus 410/network apparatus 420 updating the first precoder according to the second precoded reference signal.

In some implementations, process 600 may further involve processor 412/422 initializing the first precoder.

In some implementations, process 600 may further involve processor 412/422 determining an equivalent channel corresponding to the second precoded reference signal. Process 600 may further involve processor 412/422 updating the first precoder according to a filter.

In some implementations, process 600 may further involve processor 412/422 transmitting a third precoded reference signal precoded by the updated first precoder for updating the second precoder. Process 600 may further involve processor 412/422 receiving a fourth precoded reference signal precoded by the updated second precoder. Process 600 may further involve processor 412/422 updating the first precoder according to the fourth precoded reference signal.

In some implementations, the first precoded reference signal may include a DL-DMRS or a CSI-RS. The second precoded reference signal may include an UL-DMRS or an SRS.

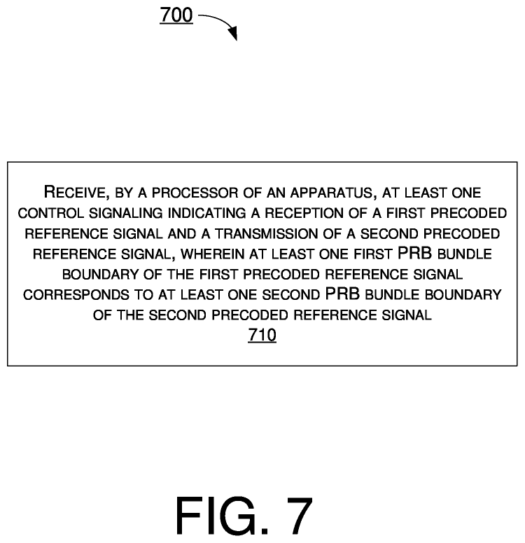

FIG. 7 illustrates an example process 700 in accordance with an implementation of the present disclosure. Process 700 may be an example implementation of above scenarios/schemes, whether partially or completely, with respect to bidirectional channel estimation of the present disclosure. Process 700 may represent an aspect of implementation of features of communication apparatus 410. Process 700 may include one or more operations, actions, or functions as illustrated by at least one block 710. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 410 or any suitable UE or machine type devices. Solely for illustrative purposes and without limitation, process 700 is described below in the context of communication apparatus 410. Process 700 may begin at block 710.

At block 710, process 700 may involve processor 412 of communication apparatus 410 receiving at least one control signaling indicating a reception of a first precoded reference signal and a transmission of a second precoded reference signal. At least one first PRB bundle boundary of the first precoded reference signal may correspond to at least one second PRB bundle boundary of the second precoded reference signal.

In some implementations, the at least one control signaling may include a transmission parameter set associated with the transmission of the second precoded reference signal. The transmission parameter set may include at least one of: a frequency domain resource allocation, a reference signal comb size, and a PRG bundle boundary and size

In some implementations, the frequency domain resource allocation may be applied to both the transmission of the second precoded reference signal and the reception of the first precoded reference signal.

In some implementations, the first precoded reference signal includes a DL-DMRS or a CSI-RS.

In some implementations, the second precoded reference signal may include at least one of an UL-DMRS and an SRS.

In some implementations, process 700 may further involve processor 412 selecting a subset of ports of the second precoded reference signal for transmission.

In some implementations, the at least one control signaling may indicate a subset of a plurality of ports of the second precoded reference signal to be transmitted.

In some implementations, the subset may correspond to a subset of antennas, and another subset of the plurality of ports may correspond to another subset of antennas.

In some implementations, the at least one control signaling may include: a first control signaling indicating the reception of the first precoded reference signal, and a second control signaling indicating the transmission of the second precoded reference signal.

In some implementations, the at least one control signaling may include a DCI or an RRC signaling.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first precoded reference signal precoded by a first precoder;
determining, by the processor, a second precoder according to the first precoded reference signal; and
transmitting, by the processor, a second precoded reference signal precoded by the second precoder for updating the first precoder.

2. The method of claim 1, wherein the determining of the second precoder according to the first precoded reference signal further comprises:
determining, by the processor, an equivalent channel corresponding to the first precoded reference signal; and
determining, by the processor, the second precoder based on the equivalent channel.

3. The method of claim 1, further comprising:
receiving, by the processor, a third precoded reference signal precoded by the updated first precoder;
updating, by the processor, the second precoder according to the third precoded reference signal; and
transmitting, by the processor, a fourth precoded reference signal precoded by the updated second precoder for updating the updated first precoder.

4. The method of claim 1, wherein the first precoded reference signal includes a Downlink-Demodulation Reference Signal (DL-DMRS) or a Channel State Information-Reference Signal (CSI-RS), and the second precoded reference signal includes an Uplink-DMRS (UL-DMRS) or a Sounding Reference Signal (SRS).

5. The method of claim 1, wherein at least one first Physical Resource Block (PRB) bundle boundary of the first precoded reference signal corresponds to at least one second PRB bundle boundary of the second precoded reference signal.

6. A method, comprising:
transmitting, by a processor of an apparatus, a first precoded reference signal precoded by a first precoder for determining a second precoder;
receiving, by the processor, a second precoded reference signal precoded by the second precoder; and
updating, by the processor, the first precoder according to the second precoded reference signal.

7. The method of claim 6, further comprising:
initializing, by the processor, the first precoder.

8. The method of claim 6, wherein the updating of the first precoder according to the second precoded reference signal further comprises:
determining, by the processor, an equivalent channel corresponding to the second precoded reference signal; and
updating, by the processor, the first precoder based on the equivalent channel.

9. The method of claim 6, further comprising:
transmitting, by the processor, a third precoded reference signal precoded by the updated first precoder for updating the second precoder;
receiving, by the processor, a fourth precoded reference signal precoded by the updated second precoder; and
updating, by the processor, the updated first precoder according to the fourth precoded reference signal.

10. The method of claim 6, wherein the first precoded reference signal includes a Downlink-Demodulation Reference Signal (DL-DMRS) or a Channel State Information-Reference Signal (CSI-RS), and the second precoded reference signal includes an Uplink-DMRS (UL-DMRS) or a Sounding Reference Signal (SRS).

11. A method, comprising:
receiving, by a processor of an apparatus, at least one control signaling indicating a reception of a first precoded reference signal and a transmission of a second precoded reference signal,
wherein at least one first Physical Resource Block (PRB) bundle boundary of the first precoded reference signal corresponds to at least one second PRB bundle boundary of the second precoded reference signal.

12. The method of claim 11, wherein the at least one control signaling includes a transmission parameter set associated with the transmission of the second precoded reference signal, and the transmission parameter set includes at least one of:
a frequency domain resource allocation;
a reference signal comb size; and
a Precoding Resource block Group (PRG) bundle boundary and size.

13. The method of claim 12, wherein the frequency domain resource allocation is applied to both the transmission of the second precoded reference signal and the reception of the first precoded reference signal.

14. The method of claim 11, wherein the first precoded reference signal includes a Downlink-Demodulation Reference Signal (DL-DMRS) or a Channel State Information-Reference Signal (CSI-RS).

15. The method of claim 11, wherein the second precoded reference signal includes at least one of an Uplink-DMRS (UL-DMRS) and a Sounding Reference Signal (SRS).

16. The method of claim 11, further comprising:
selecting, by the processor, a subset of ports of the second precoded reference signal for transmission.

17. The method of claim 11, wherein the at least one control signaling indicates a subset of a plurality of ports of the second precoded reference signal to be transmitted.

18. The method of claim 17, wherein the subset corresponds to a subset of antennas, and wherein another subset of the plurality of ports corresponds to another subset of antennas.

19. The method of claim 11, wherein the at least one control signaling includes:
a first control signaling indicating the reception of the first precoded reference signal; and
a second control signaling indicating the transmission of the second precoded reference signal.

20. An apparatus, comprising:
a transceiver which, during operation, wirelessly communicates with a wireless network; and
a processor communicatively coupled to the transceiver such that, during operation, the processor performs operations comprising:
receiving, via the transceiver, at least one control signaling indicating a reception of a first precoded reference signal and a transmission of a second precoded reference signal,
wherein at least one first Physical Resource Block (PRB) bundle boundary of the first precoded reference signal corresponds to at least one second PRB bundle boundary of the second precoded reference signal.
